(19) United States
(12) Patent Application Publication
(10) Pub. No.: US 2003/0155285 A1
(43) Pub. Date: Aug. 21, 2003

(54) Device and methods for sorting objects

(76) Inventors: Albert Heitzer, Bach (DE); Alois Schmidbauer, Wiesent (DE)

Correspondence Address: Richard B Hoffman, Marshall Gerstein & Borun, Suite 6300 Sears Tower, 233 S Wacker Drive, Chicago, IL, 60606-6357, US

(21) Appl. No.: 10/344,196

(22) PCT Filed: Sep. 4, 2002
(86) PCT No.: PCT/EP02/09892

(30) Foreign Application Priority Data
Sep. 5, 2001 (DE) 10143430.8

(51) Int. Cl. B07C 9/00

(52) U.S. Cl. 209/653

(57) ABSTRACT

The invention relates to a device and a method for sorting objects on a transport device. The device and the method are characterized in that first the friction between the object and the transport device is determined, and, on that foundation, the transfer of the object is then triggered.

### DESCRIPTION

The invention relates to a method and a device for sorting objects on a transport installation.

A device for sorting packaging units which have been identified as defective from a number of packaging units which move by is known from DE 195 32 306. In this device, a sorting device which is designed as a rotor is caused to move back and forth in a vertical plane of rotation. Here, any packaging units which are identified as defective, for example soiled or broken packaging units, and which are transported on a conveyor, can be removed by sorting, by shifting them laterally out of the stream of packaging units. The regulation of the step motor is determined as a function of the type of packaging unit. As a result, large bottles can be given a pulse-like impact by the same rotor used for the small bottles.

In such a device, it has been shown to be disadvantageous that, even if identical packaging units are removed by sorting, the movement of the packaging unit which is generated by the rotor is always individual and different, that is even if the packaging units are the same, and even if they are set in movement in the same manner by the rotor, the movement of each packaging unit is different. This is a result, on the one hand, of the fact that the bottom sides of [sic] present different degrees of wear [ . . . ]

[ . . . ]B. bottles, and, on the other hand, on areas of a conveyor which may be smooth or to which lubricant may adhere. As a result, the packaging units which are to be removed by sorting are moved over different distances, at different speeds and with different forces, for example, onto another conveyor, which can result in imprecise positioning, tipping over, or destruction of the packaging unit.

Furthermore, a device is known for transferring objects, in particular bottles, from DE 195 16 403. In this device, bottles are transferred onto a second conveyor belt with a ram which is placed so it can be moved back and forth substantially in a straight line. The above mentioned drawbacks substantially also apply to this device.

The problem of the present invention is to design a device and a method by means of which a reliable sorting of objects on a transport device can be achieved.

This problem is solved by a method having the characteristics of claim 1 and a device having the characteristics of claim 15.

In the method according to the invention, the friction between the object and the transport device is first determined. This determination is carried out individually for each individual object which is transported on the transport device or it can be determined only for each object on the transport device which is to be removed by sorting. Determination of friction here does not necessarily mean that one actually calculates a physical coefficient of friction, rather it means that a friction-dependent magnitude is determined, which makes it possible to establish how easily or how difficultly the object can be shifted on the transport device.

After the friction between the object and the transport device has been determined, a transfer movement is triggered as a function of this determined friction.

The triggering of a movement is achieved, for example by a defined transfer of a force or a pulse, by means of which the object is set in motion relative to the direction of transport. Even after the completion of triggering, the object, according to the invention, can continue to move as a result of its inertia, for example by sliding.

Because the friction is determined individually for each object, the force at which the transfer motion is triggered can be different individually for each object so that, overall, a very precise positioning or a well-defined movement of the object on the transport device is regulated.

As a result of the triggering of the transfer movement which is individually adapted to each object, a tipping of the object is prevented, and the object is also prevented from sliding too far or not far enough on the transport device. In the case of bottles this results in fewer functional breakdowns and/or breaks.

An advantageous embodiment of the method according to the invention is that the friction between the object and the transport device is determined by a predefined triggering of a measurement movement and of the measuring of the measurement movement. The predefined triggering is achieved by a predefined transfer of force or pulse, or by the triggering of the movement of the object at a predefined speed or minimum deflection. In this context, it is advantageous for the measurement movement to be clearly smaller than the transfer movement. This also means that the pulse or force triggered by the measurement movement is considerably smaller than the pulse or force used to trigger the transfer movement.

If the measurement movement is small in comparison to the transfer movement, one ensures that, during the triggering of the measurement movement, a tipping or an excess shifting of the object on the transport device is prevented.

The measurement of the measurement movement can be achieved by determining at least one value providing position-related information with regard to the object 3 on the transport device 2, during or after the performance of the measurement movement by the object, where this procedure advantageously comprises a measurement of separation.

The measurement can, however, also be carried out by determining the reaction due to a force or pulse applied to an object on the device which triggers the measurement movement.

The measurement of the measurement movement by the determination of a value which provides position-related information, or the measurement of a separation, can be carried out with relative simplicity, rapidity and reliability, and therefore it is advantageous for the method according to the invention.

Advantageously, the object on the transport device is transferred at an angle with respect to the direction of movement, which is predetermined by the transport device. The direction of the measurement movement is also substantially perpendicular with respect to the direction of transport. As a result, the objects are positioned in different positions at an angle with respect to the direction of transport, that is, for example, on one side of the transport device, or in the middle of the transport device so that during the subsequent procedure, the position of the object results in the removal by sorting of the object.

The triggering of the measurement movement and/or the transfer movement can advantageously be carried out with a ram, a cam or a brush. By means of a ram which moves back and forth, a cam which moves back and forth, or a brush, it is possible to apply well-defined forces and pulses to the object to trigger each movement.

Moreover, the triggering of the measurement movement can be advantageously implemented by means of a baffle which can be placed in the path of the objects. The baffle is arranged in such a manner that the objects transported on the transport device are shifted by the baffle in a direction at an angle to the transport device, thus triggering a measurement movement. The baffle can thereby shift all objects which are conveyed in the direction of transport. This allows a very simple and cost advantageous construction of the baffle, for example by means of a simple metal sheet, or a wire or grid. It is also conceivable to design the baffle in such a manner that it can be moved, so that the measurement movement is triggered only for those objects which are to be removed by sorting. This design advantageously led to the fact that objects which are not to be sorted will not be subjected to a measurement movement.

This design has the advantage that it prevents tipping during the measurement movement because there is no measurement movement for satisfactory packaging units and, on the other hand, the position of the object on the transport device remains unchanged for objects which are satisfactory, which is advantageous for the sorting.

It is possible to provide, on the baffle, a force or pressure measurement device for the determination of the force or pulse reaction, which is substantially at an angle to the direction of transport, and which force or pulse reaction results from the objects which have been pushed away by the baffle by a certain distance at an angle to the direction of transport, so that it is not necessary to conduct a determination of the position of the objects on the path of a separation measurement.

The transfer movement can, on the one hand, lead to an advantage in that the object is positioned in a direction perpendicular with a respect to the transport device. This means that the object on the transport device, after the transfer movement, comes to rest as far as a movement which is substantially vertical with a respect to the direction of transport is concerned. Thus, the object, after the transfer movement no longer moves relative to the moving transport device. As a result of the positioning of the object, it is thus possible to achieve a removal by sorting or a lateral shifting of the objects in different areas.

On the other hand, it is possible to design the transfer movement in such a manner that the object is moved downward from the transport device. This also simplifies the removal by sorting of the object.

A particularly advantageous embodiment variant of the method according to the invention consists in placing a ram or a cam in such a manner that the part of the ram or the cam which comes in contact with to the object prior moves close to the object in question, prior to the triggering of the transfer movement or the measurement movement, and that, subsequently, by the movement of the ram or the cam, a well-defined shifting of the object starts. As a result, an abrupt pushing of the object by the ram or the cam is prevented. Indeed, if the ram or the cam is moved toward an object from a larger distance, a strong impulse would be transferred to the object as soon as the ram or the cam comes in contact with the object, which could lead to a tipping of the object.

Advantageous embodiments of the method consist in using the method to remove by sorting objects, in particular bottles, from series of passing bottles.

Advantageously, in carrying out the method according to the invention, two or more plate, mesh chain or rolling bed conveyors are used, as transport device. It is also advantageously possible to use any other conventionally used conveyor.

The device according to the invention for moving an object on a transport device advantageously comprises a device for the determination of the friction between the object and the transport device, as well as a transfer device for transferring the object on the transport device. Using the device according to the invention, the method according to the invention can then be carried out. Using the corresponding device, it is possible to set with great precision the position which the object assumes on the transport device after the transfer device. The method according to the invention makes it possible to take into account the individual conditions of the friction of each object with the transport device during the triggering of the transfer movement.

The friction determination device advantageously comprises a triggering device which triggers a measurement movement in a predefined manner. Furthermore, a measurement device for measuring the measurement movement is advantageously included. The corresponding embodiment of the device according to the invention makes it possible to determine the friction dependent magnitude by triggering a measurement movement with a defined force and by determining the offset (separation) effected by the force. An advantageous embodiment variant of the device according to the invention consists in that the measurement device comprises, for the purpose of measuring the measurement movement, a device for measuring the position of the object, where the measurement of the position can be carried out, for example, by measuring the separation. Alternatively, there is the possibility of determining the force or pulse reaction of the individual objects by an appropriate measurement device and to determine from it the friction condition, optionally in combination with the transport rate.

The transfer device and the device for triggering the measurement movement can, in each case, advantageously comprise a ram and/or a cam and/or a brush. By means of such transfer devices it is possible to trigger and/or carry out a precise and well controlled movement of the object.

The transport device advantageously comprises one, two or more plate, mesh chain or rolling bed conveyor. The conveyor must merely be appropriate for moving the objects in a direction at an angle to the direction of transport.

Advantageously, means are provided by means of which the measurement values of the friction determination device can be determined, or read, and by means of which the transfer can be controlled. As a function of the determined friction or friction-dependent magnitude, the transfer device will trigger a transfer movement having a different force. For example, the means can consist of a PC, process computer or an electronic circuit.

In the following, a variant of the device according to the invention and of the inventive procedure is further explained with reference to the figures represented in the embodiments. In the drawing:

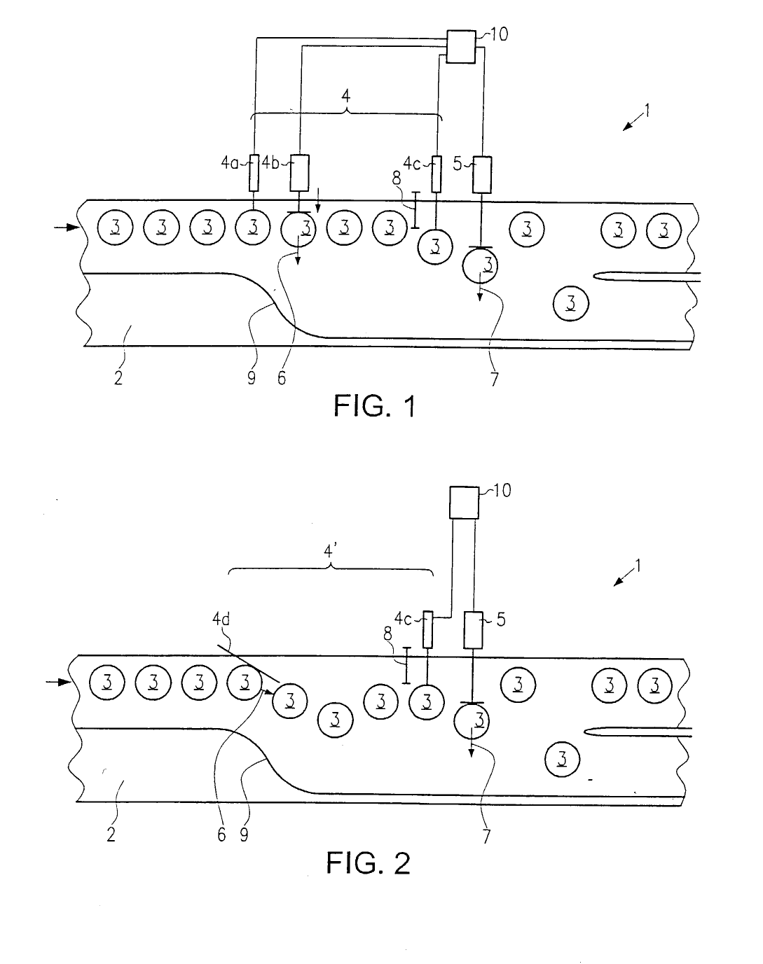

FIG. 1 shows an embodiment variant of the device according to the invention with a ram to trigger the measurement movement,

FIG. 2 shows a second embodiment of the device according to the invention with a baffle for triggering the measurement movement, and

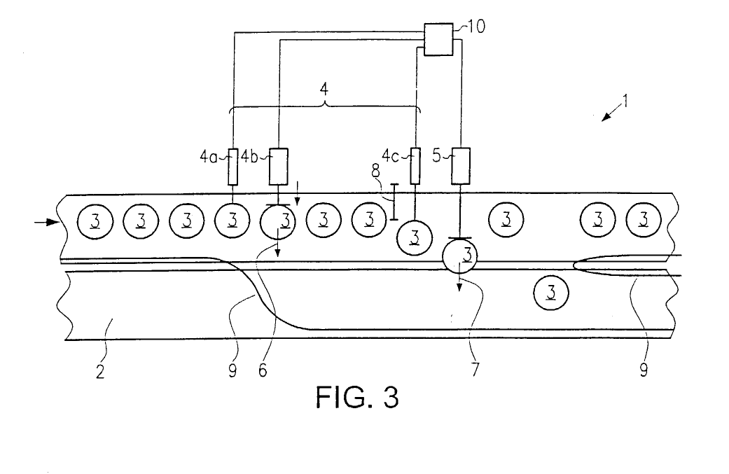

FIG. 3 shows a third embodiment of the device according to the invention, in which two transport devices are provided.

FIG. 1 represents a plate conveyor belt 2 as transport device, on which objects 3 are located. The object 3 can be bottles, for example. The representation in FIG. 1 shows the device according to the invention from the top, so that bottles appear as circles.

Using a railing 9, the space which the bottles can occupy on the plate conveyor belt is delimited. On the right end of FIG. 1, one can see that a separator which is located in the middle of the plate conveyor belt divides the area on the plate conveyor belt into two partial areas which are located next to each other. The movement of the bottles on the plate conveyor belt is from left to right in the embodiment represented in FIG. 1.

A friction determination device here consists of a separation sensor 4a, pusher 4b with a ram and an additional separation sensor 4c. The separation sensor 4a can thus first determine the separation of the bottle 3 from the left margin of the plate conveyor belt or from the separation sensor. The pusher 4b can then gently push the bottle 3 position of the bottle on the plate conveyor belt 2 with a defined force or defined pulse to trigger the measurement movement 6. The new position of the bottle on the plate conveyor belt 2, which is at an angle to the direction of conveyance, can then be determined by means of the separation sensor 4c which follows, viewed in the direction of transportation. The separation 8 which has been set in this manner can thus be compared to the separation which was acquired using the separation sensor 4a, so that one can measure how far the bottle has moved due to the triggering of the measurement movement. As a result, for this particular bottle, the friction is determined at this special place of the plate conveyor belt. Once the friction is known, the transfer movement 7 of a bottle can be carried out with the ram of the pusher 5 with a force or pulse—which may differ from object to object—which is such that the object is shifted by the desired separation at an angle to the direction of conveyance. For this purpose, a computer 10 or a circuit 10 is used which can acquire the determined values of the separation sensors 4a and/or 4c and actuate the pusher 4b and 5. The computer 10 or the circuit 10 is here designed in such a manner that, as a function of the separation value 8 which is measured by the separation sensor 4c and sent to the computer or the circuit 10, which separation value represents a measure of the existing friction, the pusher 5 is actuated in such a manner by the computer 10 or the circuit 10 that a correspondingly adapted pulse or a correspondingly adapted force is transferred to the object 3.

FIG. 2 shows an additional embodiment of the device according to the invention, in which a baffle 4d is represented, which has the effect that the bottles 3 in FIG. 2, which are deflected from the left by a railing which is not shown, with the same lateral separation with respect to the left margin of the conveyor belt, toward the opposite side of the plate conveyor belt 2. The bottles 3, which present low friction with the plate conveyor belt, here will travel over a longer separation distance than the bottles 3 with higher friction. By means of the separation sensor 4c, the separation 8 which has been set is measured, and then a controlled transfer movement can be triggered with a pusher 5, in a manner similar to the embodiment of FIG. 1. For this purpose as well a computer or an electronic circuit 10 is provided, which acquires the measurement values of the separation sensor 4c and which determines from it the required control for the pusher 5 and accordingly actuates the pusher 5.

Furthermore, it is also possible for the baffle 4d to be moveable or tiltable substantially at an angle with a respect to the direction of conveyance, so that in a set position which the baffle can assume, the bottles which are to be removed by sorting are moved by triggering the measurement movement with the baffle. In a second predefined position of the baffle, the passing bottles are not moved so that a measurement movement is not triggered for all bottles which enter from the left, rather it is only triggered for those bottles which are to be removed by sorting. For this purpose, the baffle can be such that it can be tilted or shifted out of the path of conveyance of the bottles.

Instead of a measurement of the separation of the deflected bottles, the determination of the friction conditions can be carried out by acquiring the reaction of the bottles to the baffle, which is caused by the inertia. For this purpose, a force, pressure or pulse measurement device (not shown) can be arranged on the baffle.

In the embodiment variant in FIG. 3, the transfer movement 7 is used for the purpose of transferring the bottles 3 from the plate conveyor belt represented at the top to the one represented at the bottom.

An embodiment of the method according to the invention is explained with the aid of the embodiment of the device according to the invention represented in FIG. 1. In carrying out the method according to the invention, the bottles 3 enter the plate conveyor belt 2 from the left. In the case of entering bottles, a sensor 4a is used to determine the separation of the bottle from the upper (left) margin, or also the separation of the bottle from the sensor 4a and transmit it to the computer or the circuit 10. Then, a small measurement movement 6 is triggered with the ram of a pusher 4b by a known or predefined force or pulse transfer. Because the separation between the bottles and the upper end of the plate conveyor belt or the sensor 4a is known, the ram of the pusher 4b can be brought into a position in which the bottle 3 moving in front of the ram is located immediately in front of the ram of the pusher 4b. The control of the pusher 4b is carried out by the computer or the circuit 10 At the time when the bottle 3 is located in front of the ram, the measurement movement of the bottle 3 can be initiated by means of a controlled movement of the ram in such a manner that the bottle undergoes a controlled, slow shift. An impact of the ram against the bottle 3 is prevented by the above approaching movement of the ram onto the bottle 3, which almost rules out a tipping of the bottle.

The bottles which continue to move are then measured with the separation sensor 4c in such a manner that the separation 8 from the measurement device 4c is determined. The result of the measurement is transmitted to the computer or the circuit 10. It is possible to determine the friction conditions from the measured difference in the separation.

As a result of the predefined triggered measurement movement, the bottle has assumed a new position in a direction at an angle to the plate conveyor belt. If the bottle presents low friction with the plate conveyor belts, then the bottle has moved through a large movement in a direction at an angle to the direction of conveyance. In the case of high friction, the movement based on the predefined triggered measurement is small.

Because the new position or the new separation 8 is measured with the sensor 4c and thus is known, the ram of the pusher 5 can be set with the computer or the circuit 10 in such a manner that the entering bottle 3 enters directly in front of the ram. As a result, a precise triggering of the transfer movement with the ram of the pusher 5 has been achieved and the determined friction values can be used as a foundation. If a large movement was carried out by the predefined triggered measurement movement, then the force or pulse which the pusher 5 must apply to the bottle 3 to trigger the transfer for movement is relatively small. However, in the case of high friction, the ram of the pusher 5 can apply or transfer a force or a pulse, whose level is adapted to the friction conditions, to the bottle 3. For this purpose, the control of the pusher 5 is achieved with the computer or the circuit 10.

Using the described procedure it is possible to position the bottles with the transfer movement 7 on the plate conveyor belt in such a manner that, if the direction of exit is toward the right, they are always located in a well-defined manner to the right side of the railing represented in FIG. 1. Bottles which present a low friction are also prevented from being exposed to an impact which would push them against the lower railing 9.

The method according to the invention, which can be carried out with the device represented in FIG. 2, is carried out as follows:

The bottles 3 which enter from the left in a flush left orientation are deflected by means of the baffle 4d at an angle to the direction of conveyance. Here the situation is again such that the bottles 3 which present a low friction with a plate conveyor belt are strongly deflected, while the bottles 3 with higher friction are deflected to a lesser degree. The speed at which the bottles 3 hit the baffle 4d, that is the speed of conveyance is here advantageously known or it is measured, because the extent of the deflection of the bottles 3 can depend on the speed at impact. The strength of the deflection, that is the separation 8, is measured by means of the sensor 4c. The measurement result is transmitted to the computer or to the circuit 10. From this a conclusion can be drawn regarding the friction between the bottle 3 and the plate conveyor belt 2. By means of the ram of the pusher 5, a bottle can then be transferred into the lower area of the plate conveyor belt 2, in FIG. 2. For this purpose, the pusher 5 is controlled by the computer or the circuit 10 as a function of the result of the separation measurement of the separation sensor 4c. The bottles which are not to be moved on the plate conveyor belt 2 exit to the right in the upper area of the plate conveyor belt. A baffle 4b whose installation is fixed has the advantage that the measurement movement can be triggered using means which are simple compared to FIG. 1. In the case of a moveable baffle 4b, that is a baffle which is sometimes introduced into the area of the conveyor belt of the bottles on the plate conveyor belt, it is possible to subject only those bottles which are to be transferred to a measurement movement.

The method according to the invention, as carried out with the device according to the invention of FIG. 3, consists in triggering the transfer movement 7 with the ram of a pusher 5 in such a manner that the bottles 3 are transferred from the upper conveyor belt to the separate conveyor belt 2 which is represented at the bottom. Instead of the conveyor belt represented at the bottom, it is also possible to push the bottles down from the conveyor belt and, for example, to collect them in a collection container. It is also conceivable to provide additional conveyor belts which are parallel to the conveyor belt 2 so that bottles can be shifted in a controlled manner onto different conveyor belts by pulses of different strength, with sorting, for example by color.

1. Method for sorting objects (3) on a transport device (2), consisting of these steps:
determination of the friction between an object (3) and transport device (2),
and triggering of a transfer movement (7) of the object (3) on the transport device (2) as a function of the determined friction between the object (3) and the transport device (2).

2. Method according to claim 1, characterized in that the determination of the friction between the object (3) and the transport device (2) comprises these steps:
predefined triggering of a measurement movement (6) of the object (3), and
measurement of the measurement movement.

3. Method according to claim 2, characterized in that the measurement movement (6) is small compared to the transfer movement.

4. Method according to one of claims 2 or 3, characterized in that the measurement of the measurement movement (6) comprises at least the determination of a value which provides position-related information on the object (3) on the transport device (2) and/or the determination of the reaction of the object to a device which triggers the measurement movement.

5. Method according to claim 4, characterized in that the determination of at least one value which gives position-related information comprises a separation measurement.

6. Method according to one of claims 1-5, characterized in that the object (3) is transported on the transport device (2) in the direction of movement of the transport device (2), and the transfer movement (7) and the measurement movement (6) occur substantially vertically with a respect to the direction of transport (2).

7. Method according to one of claims 1-6, characterized in that the triggering of the transfer movement (7) and/or the measurement movement (6) is carried out with a ram (4b, 5) and/or a cam and/or a brush.

8. Method according to one of claims 1-7, characterized in that the triggering of the measurement movement (6) is carried out with a baffle (4d).

9. Method according to one of claims 1-8, characterized in that the transfer movement (7) comprises a positioning of the object (3) in a direction perpendicular to the direction of transport.

10. Method according to one of claims 1-8, characterized in that the transfer movement (7) comprises a movement of the object (3) down from the transport device (2).

11. Method according to one of claims 1-10, characterized in that the triggering of the transfer movement (7) and/or the triggering of the measurement movement (6) by an approaching movement of the ram (4b, 5) to a position shortly in front of or against the object (3) and the subsequent shifting of the object (3) by the ram (4b, 5).

12. Method according to one of claims 1-11, characterized in that the transfer movement (7) is carried out for sorting or removing by sorting the object (3) from a series of passing objects (3).

13. Method according to one of claims 1-2, characterized in that the objects (3) are bottles (3) or cans.

14. Method according to one of claims 1-13, characterized in that the transport device (2) comprises one, two or more plate, mesh chain or rolling bed conveyors.

15. Device (1) for sorting objects (3) on a transport device (2) with:
a friction determination device (4) for determining the friction between the object (3) and the transport device (2), and
a transfer device (5) for transferring the object (3) onto the transport device (2) as a function of the determined friction between the object (3) and the transport device (2).

16. Method according to claim 15, characterized in that the friction determination device (4) comprises a triggering device (4b, 4d) for the predefined triggering of a measurement movement (6) as well as a measurement device (4c) for measuring the measurement movement (6).

17. Method according to claim 16, characterized in that the measurement device (4c) for measuring the measurement movement (6) comprises a device (4c) for measuring the position of the objects (3) and/or a device for determining the reaction of the object against a device which triggers the measurement movement.

18. Method according to one of claims 16 or 17, characterized in that the measurement device (4c) for measuring the measurement movement comprises a device (4c) for measuring the separation.

19. Method according to one of claims 15-18, characterized in that the transfer device (5) and/or the triggering device (4b, 4d) for the predefined triggering of a measurement movement (6) comprises a ram (4b, 5) and/or a cam and/or a brush.

20. Method according to one of claims 16-19, characterized in that the transport device (2) comprises one, two or more plate, chain mesh or a rolling bed conveyor.

21. Method according to one of claims 15-20, characterized in that the means (10) are provided for the determination of the measurement values of the friction determination device (4) and for the control of the transfer device (5).
